(19) United States
(12) Patent Application Publication
(10) Pub. No.: US 2006/0174260 A1
(43) Pub. Date: Aug. 3, 2006

(54) Recommender having display of visual cues to aid a user during a feedback process

(75) Inventor: Srinivas Gutta, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/549,882

(22) PCT Filed: Mar. 2, 2004
(86) PCT No.: PCT/IB04/00694

§ 371 Date: Sep. 16, 2005

Related U.S. Application Data
(60) Provisional application No. 60/455,145, filed on Mar. 17, 2003.

(51) Int. Cl. H04N 7/16; H04N 7/10; G06F 3/00; G06F 13/00; H04N 5/445; H04N 7/025; H04H 9/00

(52) U.S. Cl. 725/13; 725/45; 725/46; 725/34; 725/35

(57) ABSTRACT

A method for generating recommendations, the method including: prompting a user for feedback on at least one preference for generating a recommendation, the at least one preference having two or more categories associated therewith; displaying at least one visual cue corresponding to each of the two or more categories; selecting one of the two or more categories based at least in part on the corresponding at least one visual cue; and generating a recommendation based at least in part on the selecting. Preferably, the generating generates a recommendation for video content, such as a television program and the at least one preference is the genre of the television program, such as action, drama, comedy-action, suspense-action, comedy, documentary, or romance.

The present invention relates generally to recommenders, and more particularly, to a recommender having a display of visual cues to aid a user during a feedback process.

Explicit based TV recommender systems are well known in the art, such as TiVo® and ReplayTV®, respectively. Such recommender systems gather users' preferences for television programs via an explicit interface. The user is expected to select among a pre-defined set of categories like, time, genre, language, etc. Along with selecting the categories that correspond to his/her preferences, he/she could also specify the weights for the categories in some explicit based TV recommender systems. One main problem with such recommender systems is that the interpretation of some categories by the user might not have the same meaning originally intended by the provider. For example, some people may view an action program, particularly a fast action-based program (e.g., Jackie Chan type movies, etc.) as “action” while the same people would view an action program, particularly a slow action-based program as drama. They may also view the action program as a comedy-action or suspense-action film.

Therefore, there is a need in the art for a recommender having a display of visual cues to aid a user during the feedback process.

Therefore it is an object of the present invention to provide a recommender system for generating recommendations based at least in part on a feedback of a user that overcomes the disadvantages associated with prior art recommender systems.

Because explicit based TV recommender systems gather users' preferences via an explicit interface, the interpretation of some categories of content by the user might not have the same meaning originally intended by the provider of the content. To resolve this problem, the apparatus and methods of the present invention display visual cues (e.g., video clips/trailers) to the user to enable him/her to select the categories accurately in accordance with the content providers intent.

Accordingly, a method for generating recommendations is provided. The method comprising: prompting a user for feedback on at least one preference for generating a recommendation, the at least one preference having two or more categories associated therewith; displaying at least one visual cue corresponding to each of the two or more categories; selecting one of the two or more categories based at least in part on the corresponding at least one visual cue; and generating a recommendation based at least in part on the selecting.

Preferably, the generating generates a recommendation for video content. Preferably, the video content is a television program where the at least one preference is the genre of the television program. Preferably, the two or more categories associated with the genre of the television program are selected from a group consisting of action, drama, comedy-action, suspense-action, comedy, documentary, and romance. In which case, the at least one visual cue is preferably selected from a group consisting of a video clip of each genre, a trailer from each genre, textual information describing each genre, and specific examples of each genre.

The displaying preferably comprises: displaying a selection means corresponding to each of the two or more categories; and displaying the at least one visual cue corresponding to the two or more categories upon selection of the selection means. Preferably, the displaying of the selection means comprises providing a user interface having a button displayed proximate each of the two or more categories wherein the selection of the button is achieved through the user interface.

Also provided is an apparatus for generating recommendations. The apparatus comprising: means for generating a user interface for prompting a user for feedback on at least one preference for generating a recommendation, the at least one preference having two or more categories associated therewith; means for displaying at least one visual cue corresponding to each of the two or more categories on the user interface; means for selecting one of the two or more categories based from the user interface at least in part on the corresponding at least one visual cue; and a recommender for generating a recommendation based at least in part on the selection.

The recommender preferably generates a recommendation for video content. Preferably, the video content is a television program where the at least one preference is the genre of the television program. Preferably, the two or more categories associated with the genre of the television program are selected from a group consisting of action, comedy-action, suspense-action, drama, comedy, documentary, and romance. In which case, the at least one visual cue is selected from a group consisting of a video clip of each genre, a trailer from each genre, textual information describing each genre, and specific examples of each genre.

The means for displaying preferably comprises: means for displaying a selection means on the user interface corresponding to each of the two or more categories; and means for displaying the at least one visual cue corresponding to the two or more categories upon selection of the selection means. Preferably, the means for displaying the selection means comprises displaying a button on the user interface proximate each of the two or more categories.

Still provided is a computer program product embodied in a computer-readable medium for generating recommendations. The computer program product comprising: computer readable program code means for prompting a user for feedback on at least one preference for generating a recommendation, the at least one preference having two or more categories associated therewith; computer readable program code means for displaying at least one visual cue corresponding to each of the two or more categories; computer readable program code means for selecting one of the two or more categories based at least in part on the corresponding at least one visual cue; and computer readable program code means for generating a recommendation based at least in part on the selecting.

Preferably, the computer readable program code means for displaying at least one visual cue corresponding to each of the two or more categories comprises: computer readable program code means for displaying a selection means corresponding to each of the two or more categories; and computer readable program code means for displaying the at least one visual cue corresponding to the two or more categories upon selection of the selection means.

Still yet provided is a program storage device readable by machine, tangibly embodying a program of instructions executable by the machine to perform method steps for generating recommendations. The method comprising: prompting a user for feedback on at least one preference for generating a recommendation, the at least one preference having two or more categories associated therewith; displaying at least one visual cue corresponding to each of the two or more categories; selecting one of the two or more categories based at least in part on the corresponding at least one visual cue; and generating a recommendation based at least in part on the selecting.

Preferably, the displaying comprises: displaying a selection means corresponding to each of the two or more categories; and displaying the at least one visual cue corresponding to the two or more categories upon selection of the selection means.

These and other features, aspects, and advantages of the apparatus and methods of the present invention will become better understood with regard to the following description, appended claims, and accompanying drawings where:

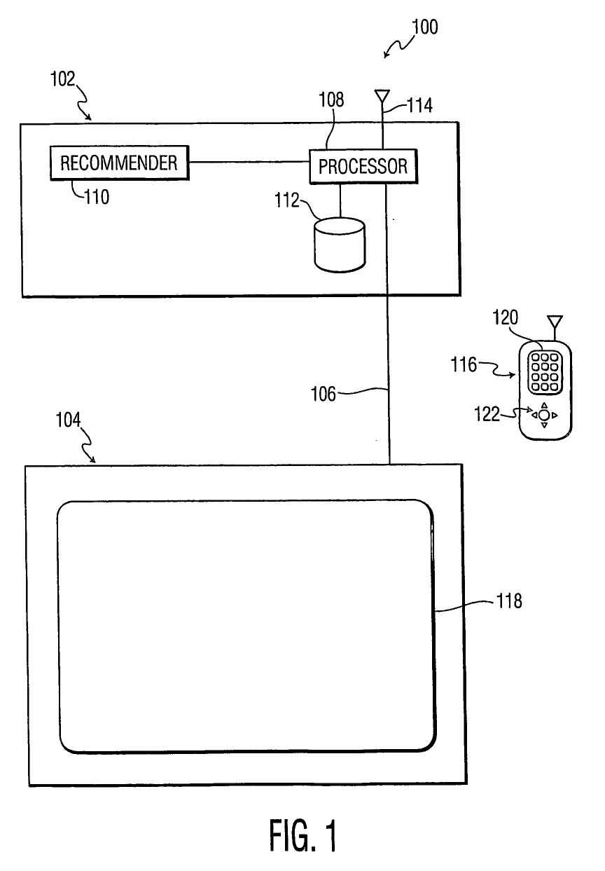

FIG. 1 illustrates a schematic illustration of a preferred implementation of an apparatus for carrying out the methods of the present invention.

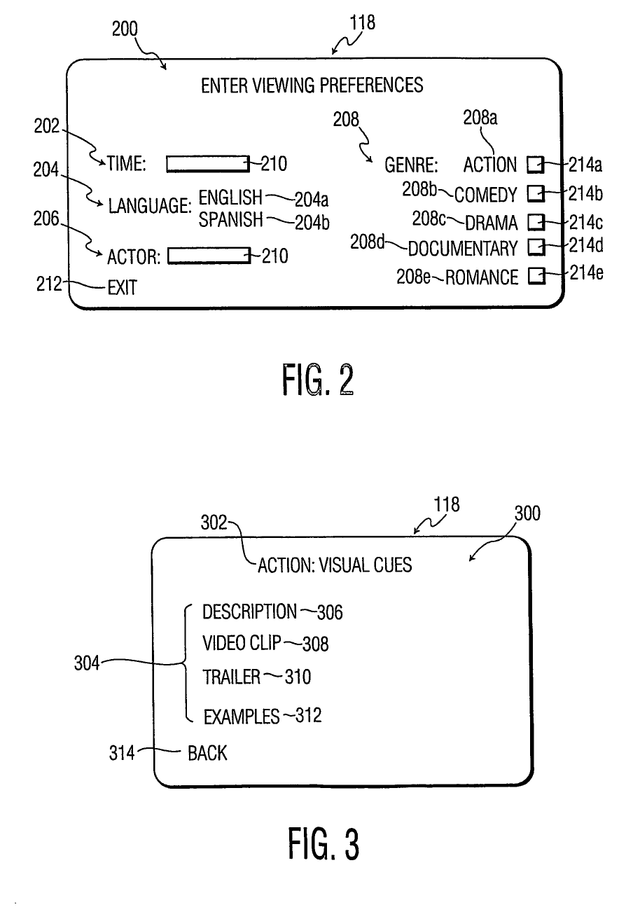

FIG. 2 illustrates a preferred implementation of a user interface for entering feedback useful for generation of a recommendation.

FIG. 3 illustrates a preferred implementation of a user interface for choosing among several visual cues for assisting a user in the selection of a category corresponding to the visual cues.

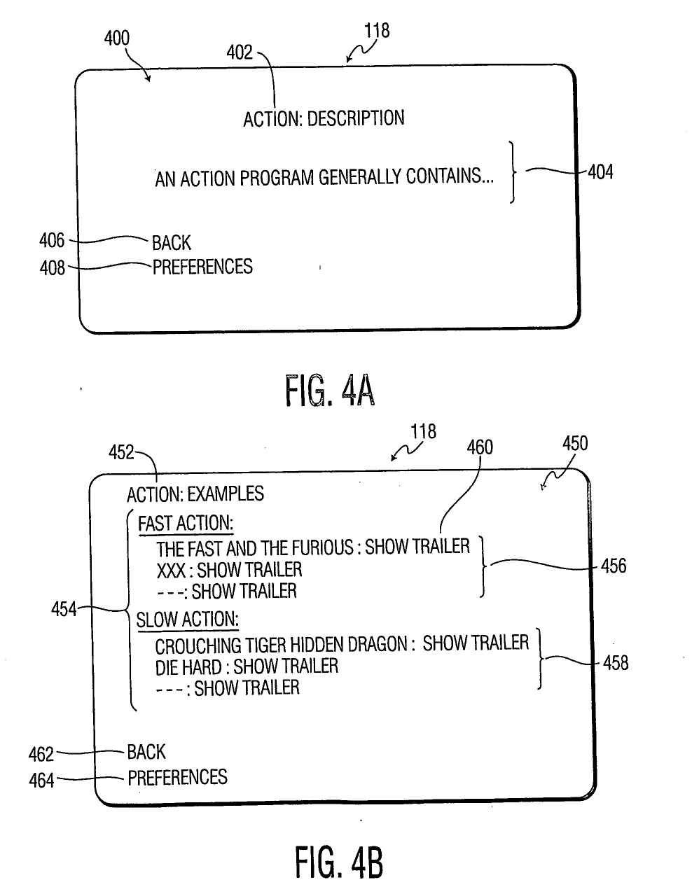

FIGS. 4A and 4B illustrate preferred implementations of a user interface displaying some of the visual cues listed in FIG. 3.

Although this invention is applicable to numerous and various types of content for which a recommendation is made, it has been found particularly useful in the environment of video content and more particularly in the environment of television programming. Therefore, without limiting the applicability of the invention to generating a recommendation for video content and television programming, the invention will be described in such environment.

Referring now to FIG. 1, there is shown a preferred implementation of an apparatus for generating recommendations, the apparatus being generally referred to by reference numeral 100. The apparatus 100 is preferably configured in a set-top box 102 operatively connected to a display 104, such as a television, by way of a video output 106. However, those skilled in the art will appreciate that the apparatus 100 can be integrally formed in the display 104. The set-top box 102 includes a central processor 108 operatively connected to a recommender 110, a storage device 112, and a receiver 114.

The recommender 110, alternatively referred to as a recommender engine, generates recommendations for video content, such as television program, or other content in response to user feedback and/or viewing habits of a user. Such recommenders 110 are well known in the art, such as that disclosed in co-pending U.S. application Ser. No. 09/666,401 filed on Sep. 20, 2000 and entitled “Method and Apparatus for Generating Recommendation Scores Using Implicit and Explicit Viewing Preferences”, the contents of which is incorporated herein by its reference. The storage device 112, such as a hard drive, stores video content for later viewing by the user and program instructions for operation of the apparatus. Although the recommender 110 is shown schematically as a separate device, it may also be contained in a set of program instructions on the storage device 112. Furthermore, although the storage device 112 is shown as a single device, it may comprise two or more storage devices, each of which is operatively connected to the processor 108.

The receiver 114 receives wireless signals from a remote control 116 indicating control signals for remote operation of the apparatus and for entering information into the apparatus through a user interface reproduced on a screen 118 of the display 104. The processor 108 receives the wireless signals from the remote control 116 and has means for de-multiplexing the same from other signals or noise and for transforming the same, if necessary, to be usable with the apparatus 100. The processor 108 further controls the recommender 110 and storage device 112, generates the user interface, and outputs the same to the display 104 for viewing on the screen 118. As is well known in the art, a user enters and traverses the user interface with the remote control 118 by pressing simple buttons 120 and/or manipulating a joystick button 122 on the remote control.

Referring now also to FIGS. 2, 3, 4A, and 4B, a preferred implementation of a method for generating recommendations will be discussed. As discussed above, some types of recommenders use feedback from a user to help in generating a recommendation for video or other content. The recommendation can be based partially or wholly on the feedback. The methods of the present invention are directed to such recommenders. Generally, a user interface, referred to in FIG. 2 by reference numeral 200, is generated and viewed on the screen 118 of the display 104 under control of the processor 108. The user interface prompts a user for feedback on at least one preference for generating a recommendation. Examples of preferences include a preferred time slot 202 (e.g., prime time, late night, weekend, etc.) a preferred language 204, such as English 204a or Spanish 204b, a preferred actor 206, and a preferred genre 208, such as action 208a, comedy 208b, drama 208c, documentary 208d, and romance 208e. Some genres, such as “action” can be further subdivided, such as comedy-action, suspense-action, slow-action, and fast-action.

The preferences 202-208 can be selected by traversing the list with the joystick button 122 on the remote control 116 and pressing an enter button when an appropriate preference 202-208 is highlighted or by entering alphanumeric text in a text box 210 corresponding to one or more of the preferences 202-208. Alternatively, the text boxes 210 can have a drop-down list of alternatives that can be traversed and selected as discussed above. The choices available for any of the preferences 202-208 are referred to herein as categories. Thus, the different choices for genre are referred to as categories 208a-208e. Of course, the preferences 202-208, as well as their categories 204a, 204b, 208a-208e are given by way of example only, not intended to be an exhaustive listing thereof, and are further not intended to limit the scope or spirit of the invention to those described. For example, other preferences include station call signal, ratings, and day of week. An “Exit” 212 choice is also provided on the user interface 200 to exit the feedback process and resume another operation of the apparatus 100 or display 104.

Because a user may have a different meaning for a category than that intended by a provider of video content, the user interface 200 further displays at least one visual cue corresponding to each of the categories 208a-208e where a meaning may not be clear. The visual cues are preferably displayed for a particular category by traversing the user interface 200 to the appropriate category, then to a button 214a-214e corresponding to the category 208a-208e, and then entering the selection of the button, such as by pressing an enter key on the remote control 116. For the purposes of illustration and not to limit the scope or spirit of the invention, the displaying of visual cues will be discussed by way of example with regard to the genre preference 208 and the action category 208a. Although, the action category is shown by way of example with two choices, fast-action and slow-action, other types of action genres can also be included, such as comedy-action and/or suspense-action.

Referring now specifically to FIG. 3, there is shown a further user interface, generally referred to by reference numeral 300, which is displayed on the screen 118 of the display 104 in response to selection of the button 214a corresponding to the action category 208a of the genre preference 208. Thus, if the user is not sure if his preference is action or drama and he/she wants clarification on which of the categories to select, he/she selects button 214a and user interface 300 is generated by the processor 108 and displayed on the screen 118. User interface 300 preferably includes a heading 302 such as “Action: Visual Cues” along with a listing 304 of individual visual cues that may be selected. The listing of individual visual cues 302 may include a textual and/or oral description 306, a video clip 308 of a representative video content from the action category, a video trailer 310 from a representative video content from the action category, and specific examples 312 of video content in the action category. The user interface 300 also preferably contains a “Back” choice 314 for returning back to user interface 200. The user traverses the list of visual cues 304 or the “Back” choice 314 and enters his/her selection similarly to that described above, namely, by using the joystick button 122 of the remote control 116 to highlight a selection and by entering the highlighted selection by pressing an enter button. A selection can also have a corresponding number which when pressed on the remote control 116 selects and enters the selection.

Referring now specifically to FIG. 4A, if the “Description” visual cue 306 is selected, the processor generates user interface 400 on the screen 118 of the display 104. User interface 400 has a heading 402 such as “Action: Description” and a textual description 404 of the action category 208a. Alternatively, or in addition, the processor can generate an oral reading of the description through a speaker (not shown) operatively connected to either the apparatus or the display 104. User interface 400 also includes a “Back” choice 406 to return to user interface 300. User interface 400 may also have a “Preferences” choice 408 for returning to user interface 200. Selection of the “Video Clip” visual cue 308 instructs the processor 108 to output a video clip of a representative action video content stored on the storage device 112. Similarly, selection of the “Video Trailer” visual cue 310 instructs the processor 108 to output a video trailer from a representative action video content stored on the storage device 112.

Referring now specifically to FIG. 4B, if the “Examples” visual cue 312 is selected, the processor generates user interface 450 on the screen 118 of the display 104. User interface 450 has a heading 452 such as “Action: Examples” and textual examples 454 of the action category 208a. The examples 454 may be further subdivided into examples, such as Fast Action 456 and Slow Action 458. Additionally, each example 454 may have a corresponding visual cue 460, such as a video trailer, selection of which instructs the processor 108 to play a video trailer from the selected example 454. User interface 450 also includes a “Back” choice 462 to return to user interface 300. User interface 450 may also have a “Preferences” choice 464 for returning to user interface 200.

Those skilled in the art will appreciate that the visual cues 304 described herein are given by way of example only, not meant to be an exhaustive listing thereof, and not intended to limit the scope or spirit of the invention. Furthermore, although the user interface is described having different displays, those skilled in the art will appreciate instead of user interface 200 changing to user interface 300, a window can appear having user interface 300 with user interface 200 displayed in the background. Similarly, user interfaces 400 and 450 can be displayed in a window with user interfaces 200 and/or 300 displayed in the background. In such a configuration, the “Exit” choice would be replaced with a “Close Window” choice.

The methods of the present invention are particularly suited to be carried out by a computer softvare program, such computer software program preferably containing modules corresponding to the individual steps of the methods. Such software can of course be embodied in a computer-readable medium, such as an integrated chip or a peripheral device, such as storage device 112.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method for generating recommendations, the method comprising:
prompting a user for feedback on at least one preference for generating a recommendation, the at least one preference having two or more categories associated therewith;
displaying at least one visual cue corresponding to each of the two or more categories;
selecting one of the two or more categories based at least in part on the corresponding at least one visual cue; and
generating a recommendation based at least in part on the selecting.

2. The method of claim 1, wherein the generating generates a recommendation for video content.

3. The method of claim 2, wherein the video content is a television program.

4. The method of claim 3, wherein the at least one preference is the genre of the television program.

5. The method of claim 4, wherein the two or more categories associated with the genre of the television program are selected from a group consisting of action, comedy-action, suspense-action, drama, comedy, documentary, and romance.

6. The method of claim 5, wherein the at least one visual cue is selected from a group consisting of a video clip of each genre, a trailer from each genre, textual information describing each genre, and specific examples of each genre.

7. The method of claim 1, wherein the displaying comprises:
displaying a selection means corresponding to each of the two or more categories; and
displaying the at least one visual cue corresponding to the two or more categories upon selection of the selection means.

8. The method of claim 7, wherein the displaying of the selection means comprises providing a user interface having a button displayed proximate each of the two or more categories wherein the selection of the button is achieved through the user interface.

9. An apparatus for generating recommendations, the apparatus comprising:
means for generating a user interface for prompting a user for feedback on at least one preference for generating a recommendation, the at least one preference having two or more categories associated therewith;
means for displaying at least one visual cue corresponding to each of the two or more categories on the user interface;
means for selecting one of the two or more categories based from the user interface at least in part on the corresponding at least one visual cue; and
a recommender for generating a recommendation based at least in part on the selection.

10. The apparatus of claim 9, wherein the recommender generates a recommendation for video content.

11. The apparatus of claim 10, wherein the video content is a television program.

12. The apparatus of claim 11, wherein the at least one preference is the genre of the television program.

13. The apparatus of claim 12, wherein the two or more categories associated with the genre of the television program are selected from a group consisting of action, comedy-action, suspense-action, drama, comedy, documentary, and romance.

14. The apparatus of claim 13, wherein the at least one visual cue is selected from a group consisting of a video clip of each genre, a trailer from each genre, textual information describing each genre, and specific examples of each genre.

15. The apparatus of claim 9, wherein the means for displaying comprises:
means for displaying a selection means on the user interface corresponding to each of the two or more categories; and
means for displaying the at least one visual cue corresponding to the two or more categories upon selection of the selection means.

16. The apparatus of claim 15, wherein the means for displaying the selection means comprises displaying a button on the user interface proximate each of the two or more categories.

17. A computer program product embodied in a computer-readable medium for generating recommendations, the computer program product comprising:
computer readable program code means for prompting a user for feedback on at least one preference for generating a recommendation, the at least one preference having two or more categories associated therewith;
computer readable program code means for displaying at least one visual cue corresponding to each of the two or more categories;
computer readable program code means for selecting one of the two or more categories based at least in part on the corresponding at least one visual cue; and
computer readable program code means for generating a recommendation based at least in part on the selecting.

18. The computer program product of claim 17, wherein the computer readable program code means for displaying at least one visual cue corresponding to each of the two or more categories comprises:
computer readable program code means for displaying a selection means corresponding to each of the two or more categories; and
computer readable program code means for displaying the at least one visual cue corresponding to the two or more categories upon selection of the selection means.

19. A program storage device readable by machine, tangibly embodying a program of instructions executable by the machine to perform method steps for generating reconimendations, the method comprising:
prompting a user for feedback on at least one preference for generating a recommendation, the at least one preference having two or more categories associated therewith;
displaying at least one visual cue corresponding to each of the two or more categories;
selecting one of the two or more categories based at least in part on the corresponding at least one visual cue; and
generating a recommendation based at least in part on the selecting.

20. The program storage device of claim 19, wherein the displaying comprises:
displaying a selection means corresponding to each of the two or more categories; and
displaying the at least one visual cue corresponding to the two or more categories upon selection of the selection means.
